(19) United States
(12) Patent Application Publication
(10) Pub. No.: US 2009/0035482 A1
(43) Pub. Date: Feb. 5, 2009

(54) Plastic wheel-cover painting method using flame plasma surface-treatment

(75) Inventor: Ho Tak Jeon, Gyeonggi-do (KR)

Correspondence Address: Edwards Angell Palmer & Dodge LLP, P.O. Box 55874, Boston, MA, 02205, US

(73) Assignees: Hyundai Motor Company, Seoul (KR); Kia Motors Corporation, Seoul (KR)

(21) Appl. No.: 11/999,937

(22) Filed: Dec. 6, 2007

(30) Foreign Application Priority Data
Jul. 30, 2007 (KR) 10-2007-0076126

(51) Int. Cl. H05H 1/24

(52) U.S. Cl. 427/569

(57) ABSTRACT

The present invention relates to a process of printing exterior plastic parts of a vehicle, and particularly to a painting process in which a flame plasma surface treatment is applied, thereby replacing the conventional pretreatment and primer process. Preferably, the flame plasma surface treatment uses as variables a gas mixing ratio of air/LPG or air/LNG to be introduced to an exterior plastic injection-molded product, a distance between a plasma source and an exterior plastic injection-molded product, a plasma treatment speed and a mixed amount of gas.

### CROSS-REFERENCE TO RELATED APPLICATION

This application claims priority to, and the benefit of, Korean Patent Application No. 10-2007-0076126, filed on Jul. 30, 2007, the entire disclosure of which is hereby incorporated by reference.

### TECHNICAL FIELD

The present invention relates to a process of printing exterior plastic parts of a vehicle, and particularly to a painting process in which a flame plasma surface treatment is applied.

### BACKGROUND ART

Exterior vehicle parts made of plastic require painting treatment from functional and aesthetic aspects.

Representative plastic exterior parts include a bumper cover, a wheel cover and an outside rear view mirror housing, and they are usually made of polyolefin (e.g., polypropylene) and nylon.

These plastic materials are subjected to functional surface treatment by means of dry coating and painting for the improvement of weatherability, abrasion resistance, corrosion resistance and appearance quality.

Processes currently used for painting exterior plastic parts includes pretreatment for removing foreign materials on the surface of products and primer coating process for improving the adhesion between products and coating layer.

More particularly, such processes for painting exterior plastic parts include the steps of:

1) injection-molding plastic parts in a designed shape and form by using resin;

2) cleaning the surface of the injection-molded plastic parts (pretreatment);

3) applying primer for increasing adhesion between the parts and the coating layer and drying the primer;

4) applying base paints to express the desired color and drying the base paints;

5) applying clear coat which is transparent or contains a photo-sensitizer (delusterant) to protect the base paint layer.

Primer is coated on the entire surface of plastic exterior parts, and base paints are coated on the primer layer. Clear coat is applied on the base paint, thus forming three layers.

Coating layers are formed by the binding between the functional groups of base paints and the functional groups of the injection-molded product surface.

However, among the exterior plastic painting parts in a vehicle, for example, the wheel cover is made of non-polar nylon, and shows insufficient adhesion to polar paints. In such case, primer is coated for improving adhesion between such parts and polar paints.

For securing adhesion between base paints and products without conducting the primer process, the surface tension of the injection-molded product is required to be increased.

In fact, the surface tension of the wheel cover products injection-molded by using nylon material is about 35 mN/m. This level of surface tension may easily cause exfoliation due to insufficient adhesion between injection-molded product surface and paints.

### SUMMARY

To overcome the aforementioned problems, the present inventors have conducted extensive researches and found that the conventional pretreatment and primer process may be omitted by using a flame plasma surface treatment.

In one aspect, the present invention provides a process for painting exterior plastic parts of a vehicle, in which a flame plasma surface treatment is applied. Preferable variables that can be used for the flame plasma surface treatment are a mixing ratio of air/LPG or air/LNG to be introduced to an exterior plastic injection-molded product, a distance between a plasma source and the exterior plastic injection-molded product, a plasma treatment speed and a mixed amount of gas.

In a preferred embodiment, the gas mixing ratio of air/LPG is about 25:1-30:1.

In another preferred embodiment, the distance is about 7-12 cm.

In a still another preferred embodiment, the plasma treatment speed is about 25-55 m/min.

In a further preferred embodiment, the mixed amount of gas is about 600-800 L/min.

In a still further preferred embodiment, the gas mixing ratio of air/LNG is less than about 25:1.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

Other aspects of the invention are discussed infra.

### DETAILED DESCRIPTION

Hereunder is provided a detailed description of the present invention.

The present invention relates to a process for painting a plastic wheel cover by using a flame plasma surface treatment. In particular, the present invention relates to a plasma surface treatment process that may omit the conventional pretreatment and primer process in the painting process of nylon wheel cover among exterior plastic parts of a vehicle.

Plasma, i.e., the fourth state of matter, refers to a state where gaseous molecules exist as charged particles (anions, cations, radicals or electrons) and electrically neutral particles (atoms) when they absorb a certain level of energy.

This plasma exists in the form of highly reactive state, and rapidly reacts with other matters. Solid surface may be chemically modified by using the highly reactive plasma.

Examples of the plasma surface treatment processes for improving adhesion include chemical etching, corona discharge treatment, electrical surface treatment and flame plasma. The most widely used process among these is the flame plasma treatment.

The flame plasma is an effective method to treat plastic materials, and is convenient to install, operate and maintain. Moreover, the flame plasma enables uniform treatment of large surface area and does not generate harmful secondary products such as ozone.

On the contrary, when treated with flame plasma, non-polar nylon surface is modified into polar state and strongly binds with polar functional group of base paints without primer coating layer, thereby enabling to omit the conventional primer process in a process of painting wheel cover parts.

Flame plasma decomposes oxygen molecules into oxygen radical, ion and atom because of high temperature combustion gas (about 1000-3000 K), and contains C, N₂, free electrons, positive charges and activated gases.

Further, the treatment using plasma, which containing functional groups such as ether (R—O—C), ester (R—C=O—Or), carboxyl (—COOH) and hydroxyl (—OH), increases adhesion with oxygen-containing particles.

In general, coating adhesion increases as the surface tension increases. According to a preferred embodiment, for increasing surface tension, a mixing ratio of air/LPG, a distance between a plasma source and the exterior plastic injection-molded product, a plasma treatment speed and a mixed amount of gas may be used as variables.

Preferable flame plasma treatment conditions in the present invention are air/LPG gas mixing ratio of about 25:1-30:1, distance between plasma source and parts of about 7-12 cm, plasma treatment speed of about 25-55 m/min and a mixed amount of a gas of about 600-800 L/min.

Gas to be introduced is an air/LPG mixed gas. When the gas mixing ratio is less than 25:1, the degree of surface modification is not sufficient because of an extremely low content of oxygen that may render polarity. When the ratio is higher than 30:1, the gas introduction may be mechanically unstable, thus lowering the reliability of gas mixing ratio.

Further, when the distance between plasma source and parts is shorter than 7 cm, the surface of parts may be damaged due to high temperature. When the distance is longer than 12 cm, adhesion property and resistance to pressurized washing after painting may not be sufficient due to insufficient degree of plasma surface treatment.

Moreover, when the plasma treatment speed is lower than 25 m/min, productivity may be decreased due to retarded plasma treatment speed. When the speed is higher than 55 m/min, the improvement of adhesion property may not be sufficient due to insufficient plasma surface treatment.

Furthermore, the mixed amount of gas is preferred to be within 600-800 L/min. When the amount is less than 600 L/min, the surface medication may not be sufficient. When the amount is more than 800 L/min, collision kinetic energy transforms into thermal energy and this causes abrupt temperature elevation because the density of oxygen active species increases due to the increase in flux. Thus, the surface of parts may be damaged.

It should be noted that the present invention is not limited to wheel cover parts of nylon material and may be applied to any interior or exterior plastic parts.

Meanwhile, LNG may be used instead of LPG. Preferable gas mixing ratio of air/LNG is less than 25:1. Main ingredients of LPG are butane and propane while LNG contains methane as a main ingredient. LNG content is to be controlled in a relatively lower level considering the difference in hydrocarbon content.

### EXAMPLES

The present invention is described more specifically by the following Examples. Examples herein are meant only to illustrate the present invention, but they should not be construed as limiting the scope of the claimed invention.

### Examples 1-9

A burner and a flame treatment unit purchased from Arcogas Company in Germany were used in a painting process herein. Commercially available LPG was used, and air was supplied by using a blower. Air and gas were mixed by using an air and gas mixing unit, and a mixed gas was supplied to a burner.

The surface treatment of a wheel-cover product prepared by injection-molding was conducted with a plasma device purchased from Arcogas Company by using variables of gas mixing ratio, distance between plasma source and parts, and plasma treatment speed as follows under the conditions of Table 1 according to Taguchi Design of Experiments L9(34).

| | |
|---|---|
| Gas mixing ratio (Air:LPG) | 28:1, 26:1 and 24:1 |
| Distance between plasma source and | 5 cm, 7.5 cm and 10 cm |
| parts | |
| Plasma treatment speed | 30 m/min, 40 m/min, 50 m/min |

In order to determine optimum conditions of the plasma surface treatment, surface tension was measured in each Example by using the test ink for the surface tension measurement, which is also used in Europe (DIN, Deutsches Institut fur Normung) and U.S. (ASTM D-2578).

Instead of painting primer, the plasma surface treatment was conducted to a wheel-cover product prepared by injection-molding of nylon66 under the conditions as presented in Table 1. Base paint [UT5790-A-SPRINGSILVER, KCC] was applied to a thickness of 20-30 μm, and dried at room temperature for 5-10 minutes. Clear coat paint [UT5015-A-9000, KCC] was applied (3040 μm), and dried at 70° C. for 30 minutes, thereby providing samples.

TABLE 1

| | Mixing | | | | | | |
|---|---|---|---|---|---|---|---|
| | Ratio | Dis- | | Surface Tension | | | |
| | (Air: | tance | Speed | 56 | 62 | 68 | 72 |
| | LPG) | (cm) | (m/min) | mN/m | mN/m | mN/m | mN/m |
| Ex. 1 | 28:1 | 5 | 30 | ◯ | ◯ | ◯ | Δ |
| Ex. 2 | 28:1 | 7.5 | 40 | ◯ | ◯ | ◯ | X |
| Ex. 3 | 28:1 | 10 | 50 | ◯ | ◯ | Δ | X |
| Ex. 4 | 26:1 | 5 | 50 | ◯ | Δ | X | X |
| Ex. 5 | 26:1 | 7.5 | 30 | ◯ | ◯ | Δ | X |
| Ex. 6 | 26:1 | 10 | 40 | ◯ | ◯ | X | X |
| Ex. 7 | 24:1 | 5 | 40 | ◯ | X | X | X |
| Ex. 8 | 24:1 | 7.5 | 50 | Δ | X | X | X |
| Ex. 9 | 24:1 | 10 | 30 | ◯ | Δ | X | X |

### Comparative Example

A wheel-cover product prepared by injection-molding of nylon66 was washed as a pretreatment. Primer was applied to the product to increasing the adhesion between the product and base paint [RP143-GREY, KCC] to a thickness of 5-10 μm, and dried at room temperature for 5-10 minutes.

Base paint was applied [UT5790-A-SPRINGSILVER, KCC] to a thickness of 20-30 μm, and dried at room temperature for 5-10 minutes. Clear coat [UT5015-A-9000, KCC] was applied to a thickness of 30-40 μm, and dried at 70° C. for 30 minutes, thereby providing a sample same as those currently under mass-production without flame plasma surface treatment.

### Test Examples

Properties of painted parts were observed as follows by using samples prepared in Examples and Comparative Example.

1) External Appearance

External appearance of the specimen prepared in Examples and Comparative Example was evaluated. Specimen was evaluated as damaged when it shows easily noticeable damages such as swelling, exfoliation, splitting, pin holes, blowhole, alien substances, scars, paint stains and orange peel. Further, if there is provided sample of a lower limit, specimen should have quality at least equivalent to that of the sample.

2) Initial Adhesion

Eleven cross-cuts per each specimen prepared in Examples and Comparative Example were made at the interval of 2 mm horizontally and vertically, respectively. The surface was cleaned with a smooth brush. Predetermined tape with a suitable width and length was attached firmly to the specimen, and forcefully detached at an angle of 90°. The number of separated scales was counted. This is called adhesion test of checkers. Of the total 100 scales, the number of the separated scales is inverse proportion to the superiority in adhesiveness.

3) Water Resistance

Specimen prepared in Examples and Comparative Example was immersed in pure water of 40±2° C. for 240 hours, and stored at room temperature for 1 hour before the adhesion test. Specimen should not show deteriorations such as discoloration, fading, swelling, splitting and decrease in adhesion and bending-resistance.

4) Resistance to Pressurized Washing

One hundred scales were made by making eleven cross-cuts per each specimen prepared in Examples and Comparative Example at the interval of 2 mm horizontally and vertically, respectively. The number of the scales that remained after the water jet test under the following conditions: pressure of 70 kg_{f}/cm², jet distance of 100 mm, jet angle of 45° C., water temperature of 23±5° C. and jet time of 30 seconds. Each property was evaluated by averaging the test values of 5 specimens, and the results are presented in Table 2.

TABLE 2

| | | | | Resistance to |
|---|---|---|---|---|
| | | Initial | Water | pressurized |
| | | adhesion | resistance | washing |
| | | (No. of | (No. of | (No. of |
| | External | separated | separated | separated |
| Category | Appearance | scales) | scales) | scales) |
| Ex. 1 | Damaged | 0 | 0 | 0 |
| Ex. 2 | Not damaged | 0 | 0 | 0 |
| Ex. 3 | Not damaged | 0 | 0 | 0 |
| Ex. 4 | Not damaged | 0 | 0 | 20 |
| Ex. 5 | Not damaged | 0 | 0 | 0 |
| Ex. 6 | Not damaged | 0 | 0 | 0 |
| Ex. 7 | Not damaged | 0 | 5 | 17 |
| Ex. 8 | Not damaged | 7 | 45 | 78 |
| Ex. 9 | Not damaged | 0 | 0 | 5 |
| Comp. | Not damaged | 0 | 0 | 0 |
| Ex. 1 | | | | |

Table 2 shows that the coating property (e.g., initial adhesion property, adhesion property after the water-resisting test and resistance to pressurized washing) increases as the surface tension increases.

Examples 1-3, 5 and 6 in Table 1 show that good coating property may be obtained without showing any exfoliation when surface tension is 62 or higher.

Example 1 showed external damages in a plastic wheel cover, which were caused by high temperature condition due to a relatively shorter distance between plasma source and parts and slower plasma treatment speed, despite the highest surface tension in Examples.

On the contrary, Examples 2-3 and 5-6 are equivalent to or even better than the commercial product (Comparative Example 1) in external appearance and coating property. This shows that the flame plasma surface treatment process herein may replace the conventional pretreatment and primer process.

The present invention provides the following effect by means of the aforementioned technical means.

Conditions for flame plasma surface treatment, such as a gas mixing ratio of air/LPG, a distance between a plasma source and an exterior plastic product prepared by injection-molding and a plasma treatment speed, are optimized in the present invention. As a result, the conventional pretreatment and primer process may be omitted, thereby reducing the manufacturing cost while increasing productivity, painting quality and durability of plastic painting parts.

Further, the present invention may be applied to any interior or exterior plastic painting parts when the conditions for plasma surface treatment are optimized considering the material of plastic parts.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A process of painting exterior plastic parts of a vehicle, in which a flame plasma surface treatment is applied by using as variables a mixing ratio of air/LPG or air/LNG to be introduced to an exterior plastic injection-molded product, a distance between a plasma source and the exterior plastic injection-molded product, a plasma treatment speed and a mixed amount of gas.

2. The process of claim 1, wherein the mixing ratio of air/LPG is about 25:1-30:1.

3. The process of claim 1, wherein the distance is about 7-12 cm.

4. The process of claim 1, wherein the plasma treatment speed is about 25-55 m/min.

5. The process of claim 1, wherein the mixed amount of gas is about 600-800 L/min.

6. The process of claim 1, wherein the gas mixing ratio of air/LNG is less than about 25:1.
